(19) United States
(12) Patent Application Publication
(10) Pub. No.: US 2009/0151436 A1
(43) Pub. Date: Jun. 18, 2009

(54) NON-CONTACT TYPE ROTATIONAL ANGLE DETECTION APPARATUS AND MANUFACTURING METHOD THEREOF

(75) Inventors: Tatsuro NAGAHORI, Chiyoda-ku (JP); Kazuhisa KURITA, Chiyoda-ku (JP); Katsunari TAKAGI, Chiyoda-ku (JP); Teruhiko MORIGUCHI, Chiyoda-ku (JP)

Correspondence Address: SUGHRUE MION, PLLC, 2100 PENNSYLVANIA AVENUE, N.W., SUITE 800, WASHINGTON, DC, 20037, US

(73) Assignee: MITSUBISHI ELECTRIC CORPORATION, Tokyo (JP)

(21) Appl. No.: 12/103,091

(22) Filed: Apr. 15, 2008

(30) Foreign Application Priority Data
Dec. 18, 2007 (JP) 2007-325785

(51) Int. Cl. G01B 7/30; B29C 65/70

(52) U.S. Cl. 73/114.36; 264/271.1

(57) ABSTRACT

A non-contact type rotational angle detection apparatus can reduce the number of parts required, improve productivity, and prevent a relative displacement between a permanent magnet and a yoke. An insert molded body is fixedly secured to a shaft and is composed of a permanent magnet and a yoke formed integrally with each other by insert molding of a resin. A non-contact sensor is disposed in an inner space formed in the insert molded body. The non-contact sensor detects a rotation angle of the shaft by detecting an azimuth of magnetic flux lines generated by the permanent magnet. The cylindrical yoke is fixedly secured by shrinkage fitting to the cylindrical permanent magnet disposed at an inner side thereof. An engagement margin between the permanent magnet and the yoke is set equal to or greater than a value which restrains a relative displacement between the permanent magnet and the yoke.

### BACKGROUND OF THE INVENTION

1. Field of the Invention

The present invention relates to a non-contact type rotational angle detection apparatus and a manufacturing method thereof in which the rotation angle of a rotatable member such as for example a throttle valve by detecting a change in the azimuth of magnetic flux.

2. Description of the Related Art

In the past, there has been known a non-contact type rotational angle detection apparatus in which the rotational angle of a throttle valve, which is used to achieve the control of an optimal amount of air with respect to an amount of fuel to be injected into an engine, is detected from the point of view of the improvement in fuel mileage of the engine, countermeasures for exhaust emissions regulations, and the improvement in running stability of a vehicle (see, for example, a first patent document: Japanese patent application laid-open No. 2004-84503).

In such a non-contact type rotational angle detection apparatus, two permanent magnets and two yokes are combined, by means of magnetic forces of the permanent magnets, with a resin gear to form a magnetic circuit, the resin gear being coupled with a rotation shaft that serves to drive the throttle valve. The magnetic circuit thus formed is then insert molded into the resin gear.

With the non-contact type rotational angle detection apparatus as constructed above, however, there are the following problems.

A. The two permanent magnets and the two yokes are used, and hence there are a lot of component parts.

B. It is necessary to assemble the two polarized permanent magnets to each other, so handling these permanent magnets is very difficult due to the discrimination of polarization thereof, the magnetic attraction thereof to peripheral equipment, etc., thus resulting in low productivity.

C. The positioning of the pair of the permanent magnets and the pair of the yokes inside a molding die at the time of insert molding is performed by utilizing the properly assembled or combined permanent magnets as well as inner and outer peripheral surfaces of the yokes, so a high degree of accuracy is required for assembling the permanent magnets and the yokes before they are inserted into the molding die. In addition, the permanent magnets and the yokes are held together only by means of the magnetic forces of the permanent magnets, so shifts in position between the permanent magnets and the yokes can easily occur before they are inserted into the molding die.

D. Since the permanent magnets and the yokes are held together only by the magnetic forces of the permanent magnets, as stated above, there will be a possibility that the permanent magnets might be shifted with respect to the yokes under the action of the molding pressure of a resin generated upon insert molding.

E. A part of the permanent magnets is exposed to the air after the insert molding is carried out, so the rust resistant performance of the permanent magnets is low, and there is a fear that rust might be generated thereon during an extended period of use.

### SUMMARY OF THE INVENTION

Accordingly, the present invention is intended to obviate the problems as referred to above.

An object of the present invention is to obtain a non-contact type rotational angle detection apparatus which can be reduced in the number of component parts required, improved in productivity, and can prevent a relative displacement between a permanent magnet and a yoke due to the molding pressure of a resin.

Another object of the present invention is to obtain a non-contact type rotational angle detection apparatus which can prevent the permanent magnet from being damaged or broken due to the molding pressure of the resin, by providing an appropriate clearance between the permanent magnet and the yoke.

A further object of the present invention is to obtain a method for manufacturing a non-contact type rotational angle detection apparatus in which at the time when insert molding is performed by the use of a polarized permanent magnet as an insert part, there will be no attachment of foreign matter to the permanent magnet, and no attraction of the permanent magnet to a molding die, thus making it possible to improve the working efficiency of the insert molding.

According to a first aspect of the present invention, there is provided a non-contact type rotational angle detection apparatus which includes: an insert molded body that is fixedly secured to a rotating member and is composed of a permanent magnet and a yoke which are formed integrally with each other by insert molding of a resin; and a non-contact sensor that is disposed in an inner space formed in the insert molded body. The non-contact sensor detects a rotation angle of the rotating member by detecting an azimuth of magnetic flux lines that are generated by the permanent magnet. The yoke of a cylindrical shape is fixedly secured by shrinkage fitting to the permanent magnet of a cylindrical shape which is disposed at an inner side of the yoke, and an engagement margin between the permanent magnet and the yoke is set equal to or greater than a value with which a relative displacement between the permanent magnet and the yoke due to a molding pressure of the resin is restrained.

According to a second aspect of the present invention, there is provided a non-contact type rotational angle detection apparatus which includes: an insert molded body that is fixedly secured to a rotating member and is composed of a permanent magnet and a yoke which are formed integrally with each other by insert molding of a resin; and a non-contact sensor that is disposed in an inner space formed in the insert molded body. The non-contact sensor detects a rotation angle of the rotating member by detecting an azimuth of magnetic flux lines that are generated by the permanent magnet. The permanent magnet of a cylindrical shape is disposed at an inner side of the yoke of a cylindrical shape with a clearance formed between an outer peripheral surface of the permanent magnet and an inner peripheral surface of the yoke. The clearance has a dimension set to an appropriate value which is equal to or less than the value of the sum of an amount of expansion of an outside radius of the permanent magnet and an amount of shrinkage of an inside radius of the yoke at the time when the permanent magnet is damaged due to a molding pressure of the resin.

According to a third aspect of the present invention, there is provided a method for manufacturing a non-contact type rotational angle detection apparatus which includes: assembling a body of the permanent magnet, which has not yet been magnetized, and the yoke with each other in a concentric manner; molding an insert molded body, which has not been magnetized, by placing the non-magnetized body of the permanent magnet and the yoke thus assembled with each other in a mold and injecting the resin into the mold; and forming the insert molded body by placing the non-magnetized insert molded body in a magnetic field, in which parallel magnetic flux lines flow, thereby to magnetize the non-magnetized body of the permanent magnet to transform it into the permanent magnet.

According to the non-contact type rotational angle detection apparatus in the first aspect of the present invention, the cylindrical yoke is fixedly secured by shrinkage fitting to the cylindrical permanent magnet which is disposed at the inner side of the yoke, and the engagement margin between the permanent magnet and the yoke is set equal to or greater than the value with which a relative displacement between the permanent magnet and the yoke due to the molding pressure of the resin is restrained. With such an arrangement, it is possible to reduce the number of component parts required, to improve productivity, and to prevent the relative displacement between the permanent magnet and the yoke.

According to the non-contact type rotational angle detection apparatus in the second aspect of the present invention, it is possible to prevent the permanent magnet from being damaged or broken due to the molding pressure of the resin, by providing an appropriate clearance between the permanent magnet and the yoke.

According to the method for manufacturing a non-contact type rotational angle detection apparatus in the third aspect of the present invention, the permanent magnet is magnetized after the insert molding thereof, so there will be no attachment of foreign matter to the permanent magnet, and no attraction of the permanent magnet to a molding die at the time when the insert molding is performed by the use of the magnetized permanent magnet as an insert part, thus making it possible to improve the working efficiency of the insert molding.

The above and other objects, features and advantages of the present invention will become more readily apparent to those skilled in the art from the following detailed description of preferred embodiments of the present invention taken in conjunction with the accompanying drawings.

### BRIEF DESCRIPTION OF THE DRAWINGS

FIG. 1 is a front elevational view of an intake air control system for an engine into which a non-contact type rotational angle detection apparatus according to a first embodiment of the present invention is built.

FIG. 2 is a cross sectional front view of the intake air control system for an engine of FIG. 1.

FIG. 3 is a cross sectional view of an insert molded body of FIG. 2.

FIG. 4 is a view when the insert molded body of FIG. 3 is seen from the direction of arrow IV.

FIG. 5 is a perspective view showing a permanent magnet and a yoke of FIG. 2.

FIG. 6 is a view showing a magnetic path in the insert molded body of FIG. 2.

FIG. 7 is an enlarged view of essential portions of FIG. 3.

FIG. 8 is an enlarged view of essential portions of FIG. 7.

FIG. 9 is a view showing how to polarize the permanent magnet of the insert molded body of FIG. 2.

FIG. 10 is an enlarged cross sectional view of essential parts showing a non-contact type rotational angle detection apparatus according to a second embodiment of the present invention.

### DESCRIPTION OF THE PREFERRED EMBODIMENTS

Now, preferred embodiments of the present invention will be described in detail while referring to the accompanying drawings. Throughout respective figures, the same or corresponding members or parts are identified by the same reference numerals and characters.

### Embodiment 1

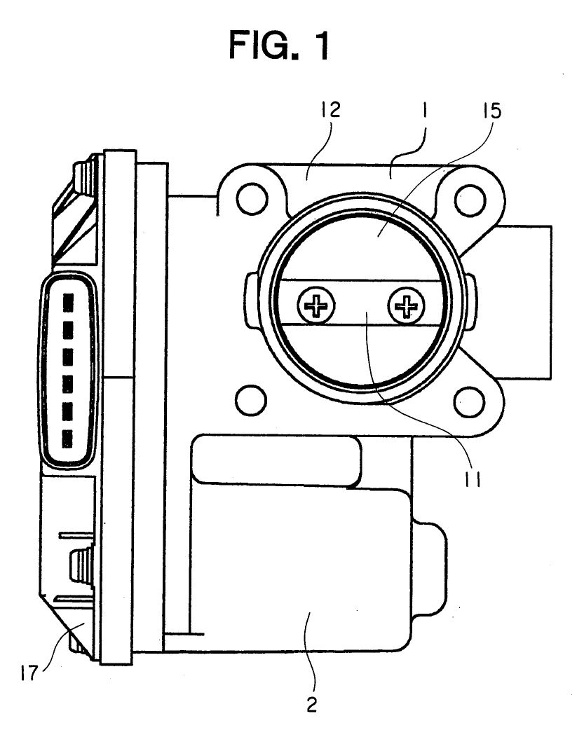

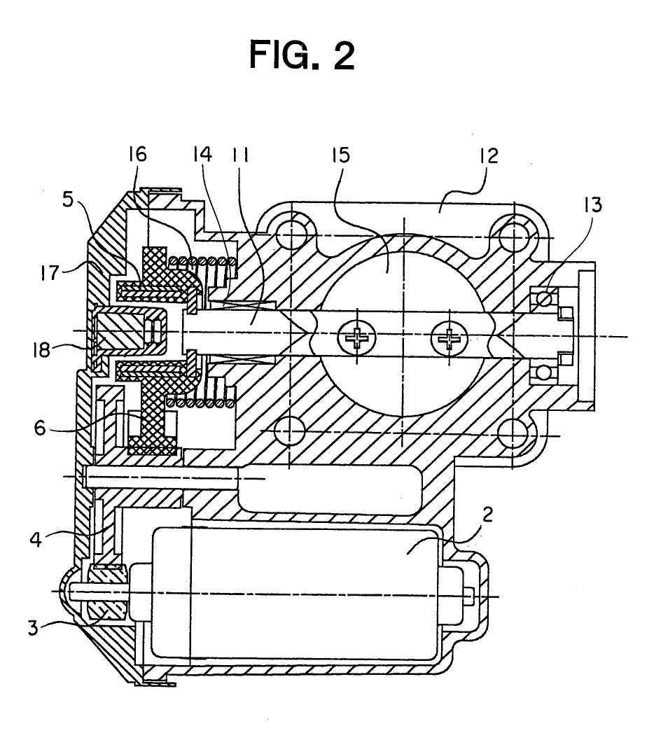

Referring to the drawings and first to FIG. 1, there is shown, in a front elevational view, an intake air control system for an engine (hereinafter referred to simply as an intake air control system) into which a non-contact type rotational angle detection apparatus (hereinafter referred to simply as a rotational angle detection apparatus) according to a first embodiment of the present invention is built. FIG. 2 is a cross sectional front view that shows the intake air control apparatus designated at a reference numeral 1 in FIG. 1.

In this intake air control system 1, a motor gear 3 is fixedly mounted on a rotation or output shaft of a drive motor 2 which is driven to rotate by direct current supplied thereto from an electric power supply (not shown). The motor gear 3 is in meshing engagement with a speed reduction gear 4 made of resin. A throttle gear 6 of an insert molded body 5 is in meshing engagement with the speed reduction gear 4.

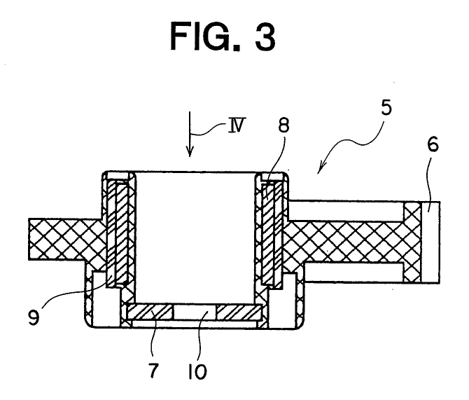

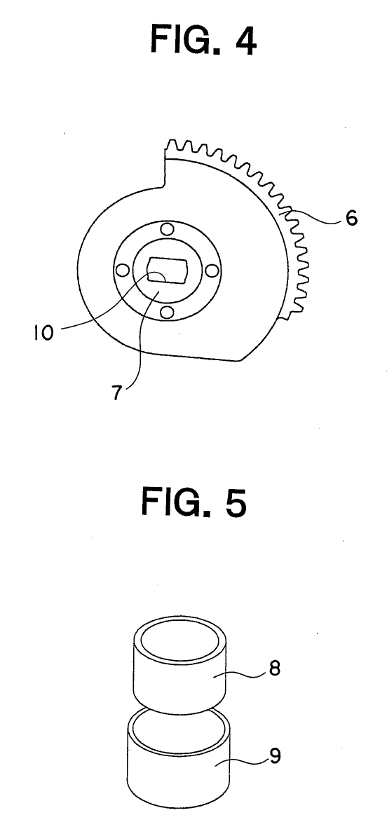

FIG. 3 is a cross sectional view of the insert molded body 5 of FIG. 2. FIG. 4 is a view when the insert molded body 5 of FIG. 3 is seen from arrow IV. FIG. 5 is perspective view that shows a permanent magnet 8 and a yoke 9.

This insert molded body 5 has a connecting plate 7 of a planar shape, the permanent magnet 8 of a cylindrical shape made of an isotropic magnet, and the yoke 9 of a cylindrical shape that is made of carbon steel and is in surface contact with an outer peripheral surface of the permanent magnet 8, all of which are integrally formed with one another by insert molding. In addition, the insert molded body 5 has the sector-shaped throttle gear 6 formed on the outer periphery thereof. The permanent magnet 8 has a pair of opposite end faces and an inner peripheral surface thereof covered with a resin that forms the throttle gear 6.

The connecting plate 7 has a hole 10 of a generally flat oval shape formed therethrough in a central portion thereof. The connecting plate 7 is fixedly secured to a shaft 11 by fitting its hole 10 over an end of the shaft 11, which has been beforehand formed so as to be inserted into the hole 10, and by caulking and crushing the shaft end. The shaft 11 is rotatably supported by a body 12 having an intake passage formed therein through a first bearing 12 and a second bearing 14. A throttle valve 15 is fixedly mounted on the shaft 11. This throttle valve 15 is always urged in a direction to close the intake passage in the body 12 under the action of a resilient force of a spring 16.

At one side surface of the body 12, there is arranged a cover 17 that serves to cover the motor gear 3, the speed reduction gear 4, and the insert molded body 5. Integrated with this cover 17 by means of insert molding is a non-contact sensor 18 that constitutes the rotational angle detection apparatus together with the permanent magnet 8 and the yoke 9. The non-contact sensor 18 is arranged on the axis of the shaft 11, and on the center line of an inner space of the cylindrical permanent magnet 8.

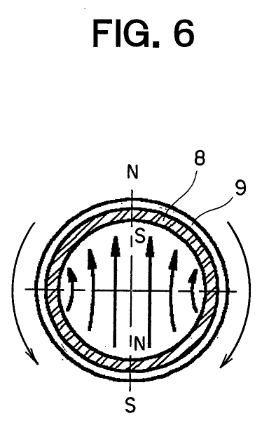

As shown in FIG. 6, the cylindrical permanent magnet 8 is magnetized or polarized into two N and S poles in the following manner. That is, a lower semicircle at an inner peripheral side becomes an N pole, an upper semicircle at the inner peripheral side becomes an S pole, a lower semicircle at an outer peripheral side becomes an S pole, and an upper semicircle at the outer peripheral side becomes an N pole. The magnetic flux of the cylindrical permanent magnet 8 flows from the N pole at its inner peripheral side to the S pole at its inner peripheral side through the inner space of the permanent magnet 8. Thereafter, the magnetic flux branches into the left and right at the S pole at the inner peripheral side, and returns to the original N pole while flowing through the cylindrical yoke 9 around the half round thereof.

In the central portion of the inner space of the permanent magnet 8, there is generated a parallel magnetic field having flux lines in parallel with respect to one another.

The non-contact sensor 18 is composed of a magnetic detection section (not shown) with a magnetoresistive element built therein for detecting the rotational angle of the shaft 11 to generate a corresponding output signal by detecting the direction of the magnetic flux of the permanent magnet 8, and an output calculation section (not shown) for operation processing the output signal from the magnetic detection section.

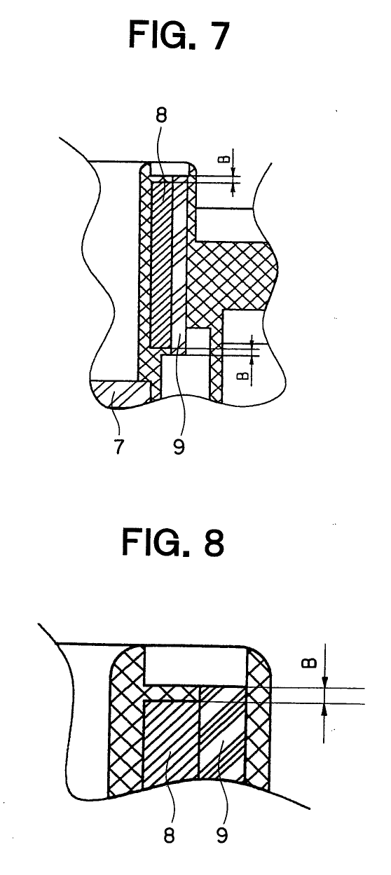

FIGS. 7 and 8 are enlarged views of essential portions of FIG. 3, wherein the permanent magnet 8 and the yoke 9 are fixedly coupled with each other by shrinkage fitting. In addition, the axial length of the permanent magnet 8 is shorter than the axial length of the yoke 9, so there are differences or steps B between the opposite end faces of the permanent magnet 8 and opposite end faces of the yoke 9, respectively, and resin is fitted or applied to such differences or steps B.

Next, reference will be made to the procedure of producing the insert molded body 5 as constructed above.

In the insert molded body 5, first of all, a cylindrical element or body before being polarized to form the permanent magnet 8 and the cylindrical yoke 9 are integrally coupled with each other by shrinkage fitting. After this, the cylindrical element or body and the cylindrical yoke 9 thus integrally coupled with each other are placed in a mold, and resin is injected into the mold thereby to form an insert molded body 5A which has not yet been magnetized or polarized.

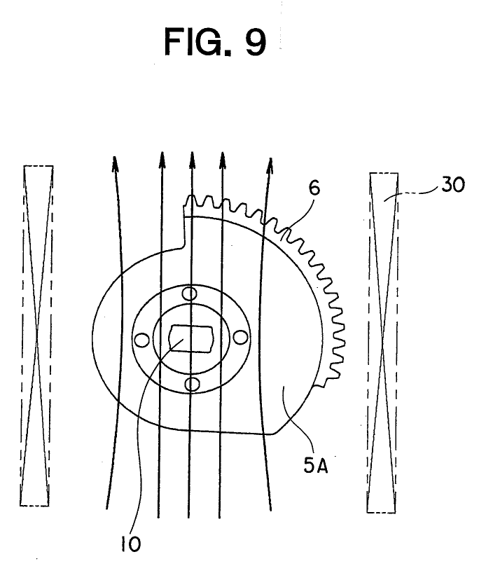

After this, as shown in FIG. 9, the non-magnetized or non-polarized insert molded body 5A is placed in the central portion of an air-core magnetizing or polarizing coil 30, after which an electric current is supplied to the magnetizing coil 30.

As a result, a parallel magnetic field is generated in the air core of the magnetizing coil 30, whereby the cylindrical member or body is magnetized or polarized so as to generate a parallel magnetic field in the central portion of an inner space thereof. As a result, the insert molded body 5 is produced with the cylindrical member or body being transformed into the permanent magnet 8.

Next, reference will be made to an appropriate engagement margin between the outer peripheral surface of the permanent magnet 8 and the inner peripheral surface of the yoke 9.

In this embodiment of the present invention, the permanent magnet 8 is the non-magnetized or non-polarized cylindrical member or body at the time when resin is injected into the mold, but in the following explanation, reference will be made, by way of example, to the case where the permanent magnet 8 has already been magnetized or polarized when the resin is injected into the mold.

An engagement margin between the permanent magnet 8 and the yoke 9 is set so as not to cause a relative displacement or shift in position between the permanent magnet 8 and the yoke 9 due to the molding pressure of the resin generated at the time of insert molding.

Assuming that the frictional force between the permanent magnet 8 and the yoke 9 is F, the coefficient of friction between the permanent magnet 8 and the yoke 9 is μ, the normal component of reaction between the permanent magnet 8 and the yoke 9 is N, the pressure between the contact portions of the permanent magnet 8 and the yoke 9 is Pₘ, the length of the permanent magnet 8 is l, and the outside radius of the permanent magnet 8 is r₂, the contact pressure Pₘ between the contact portions of the permanent magnet 8 and the yoke 9 is set as shown in the following expression (1) so as to ensure a necessary holding force H for preventing the displacement in position between the permanent magnet 8 and the yoke 9 due to the molding pressure at the time of resin molding.

$$\begin{matrix}F = μ N \\ = μ \cdot {P}_{m} \cdot 2 π {r}_{2} \cdot l > H\end{matrix} \qquad ( 1 )$$

Here, because of the shrinkage fitting, the outside radius r₂ of the permanent magnet 8 and the inside radius r₃ of the yoke 9 become equal to each other (i.e., r₂=r₃=rₘ), so the following expression (2) holds between the engagement margin δ and the contact pressure Pₘ.

$$δ = \frac{2 {P}_{m} {r}_{m}}{{E}_{Mg}} ( \frac{{r}_{1}^{2} + {r}_{m}^{2}}{{r}_{m}^{2} - {r}_{1}^{2}} - {v}_{Mg} ) + \frac{2 {P}_{m} {r}_{m}}{{E}_{Yo}} ( \frac{{r}_{m}^{2} + {r}_{4}^{2}}{{r}_{4}^{2} - {r}_{m}^{2}} + {v}_{Yo} ) \qquad ( 2 )$$

where the inside radius of the permanent magnet 8 is r₁, the outside radius of the yoke 9 is r₄, the modulus of longitudinal elasticity of the permanent magnet 8 is E_{Mg}, the Poisson ratio of the permanent magnet 8 is ν_{Mg}, the modulus of longitudinal elasticity of the yoke 9 is E_{YO}, and the Poisson ratio of the yoke 9 is ν_{YO}.

Accordingly, by setting the engagement margin δ in such a manner as to make the following expression (3) hold, it is possible to obtain a construction in which there occurs no positional displacement between the permanent magnet 8 and the yoke 9 even under the action of the molding pressure generated upon resin molding.

$$δ > \frac{H}{πμ {lE}_{Mg}} ( \frac{{r}_{1}^{2} + {r}_{m}^{2}}{{r}_{m}^{2} - {r}_{1}^{2}} - {v}_{Mg} ) + \frac{H}{πμ {lE}_{Yo}} ( \frac{{r}_{m}^{2} + {r}_{4}^{2}}{{r}_{4}^{2} - {r}_{m}^{2}} + {v}_{Yo} ) \qquad ( 3 )$$

In the intake air control system of the above-mentioned construction, when a driver depresses an accelerator pedal of a vehicle (not shown), an accelerator opening sensor (not shown) generates a corresponding accelerator opening signal, which is input to an engine control unit (hereinafter referred to as an “ECU”). The ECU supplies an electric current to the drive motor 2 in such a manner that the output or rotating shaft of the drive motor 2 is driven to rotate so as to move the throttle valve 15 to a prescribed degree of opening. Then, the insert molded body 5 having the motor gear 3, the speed reduction gear 4 and the throttle gear 6 is driven to rotate together with the output or rotating shaft of the drive motor 2. As a result, the shaft 11, being formed integral with the insert molded body 5, is caused to rotate by a predetermined rotational angle, whereby the throttle valve 15 is held at a predetermined rotational angle in the intake passage formed in the body 12.

On the other hand, in the non-contact sensor 18 of a magnetic flux azimuth detection type, the magnetic detection section thereof detects the azimuth of the magnetic flux lines from the permanent magnet 8 rotating integrally with the shaft 11, and generates a corresponding output signal to the output calculation section. The output signal from the magnetic detection section is processed by the output calculation section, and then is sent to the ECU as a throttle opening signal of the throttle valve 15, whereby based on the throttle opening signal, the ECU determines how much fuel is to be injected into each cylinder of the engine.

The operating or rotational range of the magnetic flux lines is in a range from 0 degrees, at which the throttle valve 15 is fully closed, to 90 degrees, at which the throttle valve 15 is fully opened, and in this range, the non-contact sensor 18 responds linearly to the rotational angle of the throttle valve 15.

As described in the foregoing, according to the rotational angle detection apparatus of this first embodiment, the permanent magnet 8 is of a cylindrical shape, and it is polarized after the insert molding thereof, so it becomes unnecessary to use a positioning mechanism and related positioning parts for adjusting the circumferential position of the permanent magnet 8 in a molding die.

In addition, it is possible to prevent the reduction in directivity of a parallel magnetic field, which would otherwise be caused, in the aforementioned prior art, by a relative displacement in position of a pair of permanent magnets with respect to each other in case where the pair of permanent magnets arranged in opposition to each other are used.

Moreover, the permanent magnet 8 is magnetized or polarized so as to form two magnetic poles at the same time, so there will be no variation in the amounts of magnetic fluxes of permanent magnets, which would otherwise be generated, for example, in case where a pair of permanent magnets polarized in individually different lots are used, thus making it easy to ensure a uniform parallel magnetic field.

Further, the permanent magnet 8 is constructed by the use of an isotropic magnet, so it is possible to obtain a uniform magnetization over the entire circumference of the permanent magnet 8 without generating irregularities in magnetization.

Furthermore, since the permanent magnet 8 is magnetized or polarized after the insert molding thereof, there will be no attachment of foreign matter to the permanent magnet 8 and no attraction of the permanent magnet 8 to the molding die at the time when the insert molding is carried out with the permanent magnet 8, which has already been magnetized or polarized, being used as an insert part, as a result of which the working efficiency of the insert molding can be improved.

In addition, the yoke 9 surrounding the entire outside circumference of the permanent magnet 8 serves to carry out a function as a magnetic path, so the amount of leakage of the magnetic flux to the outside can be reduced.

Moreover, the permanent magnet 8 and the yoke 9 are fixedly coupled with each other by shrinkage fitting, so it is possible to prevent the occurrence of a relative displacement between the permanent magnet 8 and the yoke 9 due to the molding pressure of the resin.

Further, by means of the contact pressure Pₘ between the contact portions of the permanent magnet 8 and the yoke 9 generated upon shrinkage fitting thereof, it is possible to ensure the sufficient holding force H that serves to prevent the occurrence of a displacement in position between the permanent magnet 8 and the yoke 9 at the time of insert molding, and the holding force H can be set in an arbitrary manner by the use of an appropriate amount of engagement margin between the permanent magnet 8 and the yoke 9.

In addition, the axial length of the permanent magnet 8 is shorter than the axial length of the yoke 9, so there are formed the differences or steps B between the opposite end faces of the permanent magnet 8 and the opposite end faces of the yoke 9, respectively. At the time of resin molding, molten resin is caused to flow to the differences or steps B, so that all the surface of the permanent magnet 8 is completely covered with the resin and the yoke 9, as a result of which the permanent magnet 8 is prevented from being exposed to the outside, thus making it possible to improve the rust resistant property of the permanent magnet 8 to a substantial extent.

### Embodiment 2

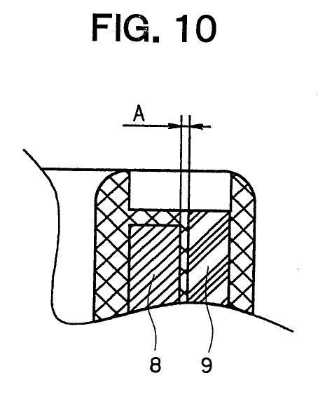

FIG. 10 is an enlarged cross sectional view of essential parts that shows a non-contact type rotational angle detection apparatus according to a second embodiment of the present invention.

In this second embodiment, there is an all-around clearance A between the outer peripheral surface of the permanent magnet 8 and the inner peripheral surface of the yoke 9. The other construction of this second embodiment is similar to that of the first embodiment.

If the clearance A exceeds a proper range, the permanent magnet 8 will be damaged by the molding pressure generated at the time of resin molding. That is, when insert molding is carried out after the cylindrical permanent magnet 8 and the cylindrical yoke 9 are combined or assembled with each other, the molding pressure generated at this time is mainly applied to the permanent magnet 8 in a direction from an inner peripheral side to an outer peripheral side thereof, and is also applied to the yoke 9 in a direction from an outer peripheral side to toward an inner peripheral side thereof, so the outside diameter of the permanent magnet 8 is caused to expand, and the inside diameter of the yoke 9 is caused to shrink or contract, whereby when the value of a tensile stress generated in the permanent magnet 8 exceeds a predetermined value, the permanent magnet 8 will be damaged.

Next, reference will be made to an appropriate value of the clearance A between the outer peripheral surface of the permanent magnet 8 and the inner peripheral surface of the yoke 9.

Here, note that in this second embodiment of the present invention, too, similar to the above-mentioned first embodiment, the permanent magnet 8 is a non-magnetized or non-polarized cylindrical member or body at the time when resin is injected into a mold, but in the following explanation, reference will be made, by way of example, to the case where the permanent magnet 8 has already been magnetized or polarized when the resin is injected into the mold.

A displacement u_{Mg} of the outside radius of the permanent magnet 8, which is caused to expand under the action of the molding pressure generated at the time of insert molding thereof, is obtained according to the following expression (4).

$${u}_{Mg} = \frac{2 {Pr}_{1}^{2} {r}_{2} - {P}_{2} {r}_{2} ⌊ ( 1 - {v}_{Mg} ) {r}_{2}^{2} + ( 1 + {v}_{Mg} ) {r}_{1}^{2} ⌋}{{E}_{Mg} ( {r}_{2}^{2} - {r}_{1}^{2} )} \qquad ( 4 )$$

where an internal pressure which is applied to the permanent magnet 8 is denoted by P₁, and an external pressure which is applied to the permanent magnet 8 is denoted by P₂.

At this time, a circumference stress σₜ generated in the permanent magnet 8 by means of the molding pressure is obtained according to the following expression (5).

$${σ}_{t} = \frac{{P}_{1} {r}_{1}^{2} ( {r}_{2}^{2} + {r}^{2} ) - {P}_{2} {r}_{2}^{2} ( {r}^{2} + {r}_{1}^{2} )}{( {r}_{2}^{2} - {r}_{1}^{2} )} \qquad ( 5 )$$

Accordingly, in order to prevent the permanent magnet 8 from being cracked due to the molding pressure, the circumference stress σₜ acting on the permanent magnet 8 at an arbitrary radius r thereof should be set to be equal to or less than a tensile strength σ_{yield} of the permanent magnet 8, that is, it should be set so as to satisfy the following expression (6).

σₜ<σ_{yield} (6)

On the other hand, because the yoke 9 is caused to shrink by means of the molding pressure, a displacement u_{Y0} of the inside radius of the yoke 9 at that time is shown according to the following expression (7).

$${u}_{Yo} = \frac{{P}_{3} {r}_{3} [ ( 1 - {v}_{Yo} ) {r}_{3}^{2} + ( 1 - {v}_{Yo} ) {r}_{4}^{2} ] - 2 {P}_{4} {r}_{3} {r}_{4}^{2}}{{E}_{Yo} ( {r}_{4}^{2} - {r}_{3}^{2} )} \qquad ( 7 )$$

where an internal pressure which is applied to the yoke 9 is denoted by P₃, and an external pressure which is applied to the yoke 9 is denoted by P₄.

From the above, assuming that the displacement of the outside radius of the permanent magnet 8 is u′_{Mg} and the displacement of the inside radius of the yoke 9 is u′_{YO} when σₜ=σ_{yield}, it is possible to prevent the damage or breakage of the permanent magnet 8 due to the molding pressure by setting the clearance A between the permanent magnet 8 and the yoke 9 in such a manner that it is modified to a clearance δ_{c} by taking account of an amount of shrinkage displacement of the yoke 9 in addition to an amount of allowable displacement of the permanent magnet 8, as shown in the following expression (8).

δ_{c}<|u′_{Mg}|+|u′_{Yo}| (8)

As described in the foregoing, according to the rotational angle detection apparatus of this second embodiment, the same advantageous effects as those in the abovementioned first embodiment can be achieved, and in addition thereto, the following advantageous effects can also be obtained.

The permanent magnet 8 is disposed at the inner side of the yoke 9 with the clearance A being formed between the outer peripheral surface of the permanent magnet 8 and the inner peripheral surface of the yoke 9, and the dimension of the clearance A is set to an appropriate value which is equal to or less than the value of the sum of an amount of expansion or increase of the outside radius of the permanent magnet 8 and an amount of shrinkage or decrease of the inside radius of the yoke 9 at the time when the permanent magnet 8 is damaged or broken due to the molding pressure of resin generated at the time of resin molding. With such an arrangement, the permanent magnet 8 can be prevented from being damaged or broken by the molding pressure of the resin.

In addition, the diameter of the yoke 9, which is combined or assembled with the permanent magnet 8 along the outer peripheral surface thereof, is caused to displace in a direction to shrink or contract due to the molding pressure applied thereto from the outer peripheral side thereof, so the setting range of the dimensions of the permanent magnet 8 can be made wider with a margin equal to the amount of shrinkage of the yoke 9, and the coupling or assembly of the yoke 9 with respect to the permanent magnet 8 becomes simpler and easier, thus making it possible to accordingly improve the productivity of the apparatus as a whole.

Here, note that the existence of the clearance A between the permanent magnet 8 and the yoke 9 has the advantage of making it easy to couple or assemble the permanent magnet 8 and the yoke 9 with respect to each other when the insert molded body 5 is produced by means of insert molding, but such a clearance A becomes a factor that causes a displacement in position of the permanent magnet 8 relative to the yoke 9 at the time of or after the insert molding.

For the purpose of preventing such a positional displacement between the permanent magnet 8 and the yoke 9, a bonding material can be filled into the clearance or space A between the permanent magnet 8 and the yoke 9 prior to the insert molding, so that the permanent magnet 8 and the yoke 9 can be fixedly secured to each other in advance.

Since the clearance A between the outer peripheral surface of the permanent magnet 8 and the inner peripheral surface of the yoke 9 is set to the appropriate value as referred to above, at that time, even in case where the bonding material is not filled into the clearance A to any satisfactory extent, leaving the clearance A unfilled or as it is, the permanent magnet 8 will by no means be damaged or broken under the action of the molding pressure.

Here, note that in actuality, it may sometimes be difficult to properly control the amount of the bonding material to be injected or supplied so as to prevent shortage and surplus of the bonding material, or to make sure whether the bonding material has been filled into the clearance without any problem. In the example of integrating the permanent magnet 8 and the yoke 9 with each other by means of shrinkage fitting according to the first embodiment, there will be no such inconveniences or difficulties.

Although in the above-mentioned first and second embodiments, reference has been made to the rotational angle detection apparatuses each built into an intake air control system for an engine that detects the degree of opening of a throttle valve, it is of course needless to say that the present invention can also be applied to apparatuses that are able to detect the rotational angles of a variety of rotating members other than these ones.

While the invention has been described in terms of preferred embodiments, those skilled in the art will recognize that the invention can be practiced with modifications within the spirit and scope of the appended claims.

What is claimed is:

1. A non-contact type rotational angle detection apparatus comprising:
an insert molded body that is fixedly secured to a rotating member and is composed of a permanent magnet and a yoke which are formed integrally with each other by insert molding of a resin; and
a non-contact sensor that is disposed in an inner space formed in said insert molded body;
wherein said non-contact sensor detects a rotation angle of said rotating member by detecting an azimuth of magnetic flux lines that are generated by said permanent magnet; and
said yoke of a cylindrical shape is fixedly secured by shrinkage fitting to said permanent magnet of a cylindrical shape which is disposed at an inner side of said yoke, and an engagement margin between said permanent magnet and said yoke is set equal to or greater than a value with which a relative displacement between said permanent magnet and said yoke due to a molding pressure of said resin is restrained.

2. A non-contact type rotational angle detection apparatus comprising:
an insert molded body that is fixedly secured to a rotating member and is composed of a permanent magnet and a yoke which are formed integrally with each other by insert molding of a resin; and
a non-contact sensor that is disposed in an inner space formed in said insert molded body;
wherein said non-contact sensor detects a rotation angle of said rotating member by detecting an azimuth of magnetic flux lines that are generated by said permanent magnet; and
said permanent magnet of a cylindrical shape is disposed at an inner side of said yoke of a cylindrical shape with a clearance formed between an outer peripheral surface of said permanent magnet and an inner peripheral surface of said yoke, and said clearance has a dimension set to an appropriate value which is equal to or less than the value of the sum of an amount of expansion of an outside radius of said permanent magnet and an amount of shrinkage of an inside radius of said yoke at the time when said permanent magnet is damaged due to a molding pressure of said resin.

3. The non-contact type rotational angle detection apparatus as set forth in claim 2, wherein a bonding material is interposed in said clearance.

4. The non-contact type rotational angle detection apparatus as set forth in any one of claims 1 through 3, wherein said permanent magnet has an axial length which is shorter than an axial length of said yoke with steps between opposite end faces of said permanent magnet and opposite end faces of said yoke, respectively, and said resin is disposed in said steps so that the opposite end faces of said permanent magnet are covered with said resin.

5. The non-contact type rotational angle detection apparatus as set forth in any one of claims 1 through 3, wherein said insert molded body has a throttle gear that is driven to rotate by a drive motor, and a throttle valve for adjusting an amount of air to be supplied to an engine is operated by the rotation of said throttle gear.

6. A method for manufacturing a non-contact type rotational angle detection apparatus which is set forth in any one of claims 1 through 3, said method comprising:
a step of assembling a body of said permanent magnet, which has not yet been magnetized, and said yoke with each other in a concentric manner;
a step of molding an insert molded body, which has not been magnetized, by placing the non-magnetized body of said permanent magnet and said yoke thus assembled with each other in a mold and injecting said resin into said mold; and
a step of forming said insert molded body by placing said non-magnetized insert molded body in a magnetic field, in which parallel magnetic flux lines flow, thereby to magnetize the non-magnetized body of said permanent magnet to transform it into said permanent magnet.
